(19) United States
(12) Patent Application Publication
(10) Pub. No.: US 2024/0136498 A1
(43) Pub. Date: Apr. 25, 2024

(54) ALL-SOLID-STATE BATTERY

(71) Applicants: TOYOTA JIDOSHA KABUSHIKI KAISHA, Toyota-shi (JP); PANASONIC HOLDINGS CORPORATION, Kadoma-shi (JP)

(72) Inventors: Akio MITSUI, Anjo-shi (JP); Kazuhiro MORIOKA, Takatsuki-shi (JP); Koichi HIRANO, Hirakata-shi (JP)

(73) Assignees: TOYOTA JIDOSHA KABUSHIKI KAISHA, Toyota-shi (JP); PANASONIC HOLDINGS CORPORATION, Kadoma-shi (JP)

(21) Appl. No.: 18/482,389

(22) Filed: Oct. 5, 2023

(30) Foreign Application Priority Data
Oct. 20, 2022 (JP) 2022-168952

(51) Int. Cl. H01M 4/131; H01M 4/505; H01M 4/525; H01M 4/58

(52) U.S. Cl. CPC H01M 4/131; H01M 4/505; H01M 4/525; H01M 4/5825; H01M 2004/021

(57) ABSTRACT

An all-solid-state battery has a positive electrode layer, a separator layer and a negative electrode layer. The all-solid-state battery satisfies relationships of “Formula (1): 0.99≤Sₐ₀/S_{c0}≤1.01,” “Formula (2): 1.00≤Sₐ₁/Sₐ₀≤1.13,” and “Formula (3): 0.93≤S_{c1}/S_{c0}≤1.02.” S_{c0} indicates an area of the positive electrode layer when the SOC is 0%. S_{c1} indicates an area of the positive electrode layer when the SOC is 100%. Sₐ₀ indicates an area of the negative electrode layer when the SOC is 0%. Sₐ₁ indicates an area of the negative electrode layer when the SOC is 100%.

### CROSS-REFERENCE TO RELATED APPLICATION

This application claims priority to Japanese Patent Application No. 2022-168952 filed on Oct. 21, 2022, incorporated herein by reference in its entirety.

### BACKGROUND

### 1. Technical Field

The present disclosure relates to an all-solid-state battery.

### 2. Description of Related Art

Japanese Unexamined Patent Application Publication No. 2021-061102 (JP 2021-061102 A) discloses that an electrode active material layer and a counter electrode active material layer are located at the same position in a plan view.

### SUMMARY

An all-solid-state battery (which may hereinafter be abbreviated as “battery”) includes a power generation element. The power generation element is formed by laminating a positive electrode layer, a separator layer and a negative electrode layer. The power generation element has a side end surface. The side end surface is an end surface parallel to the lamination direction (thickness direction). Generally, the side end surface has a step. A step is formed because each layer has a different area. For example, even if positional displacement occurs between the positive electrode layer and the negative electrode layer in the laminate, since the positive electrode layer does not protrude from the negative electrode layer, the negative electrode layer may have a larger area than the positive electrode layer.

Removing the step on the side end surface is also being examined. That is, a structure in which the positive electrode layer and the negative electrode layer are flush with each other (hereinafter referred to as a “flush structure”) on the side end surface is being examined. The flush structure is simple. When the structure is simplified, for example, improvement in material efficiency and mass productivity is expected. For example, after the power generation element is formed (after lamination), a flush structure can be formed by cutting the power generation element. However, in the flush structure, the amount of self-discharge tends to increase. Therefore, an object of the present disclosure is to reduce the amount of self-discharge.

1. An all-solid-state battery according to one aspect of the present disclosure has a positive electrode layer, a separator layer and a negative electrode layer.

The separator layer is disposed between the positive electrode layer and the negative electrode layer.

The all-solid-state battery satisfies relationships of the following Formulae (1) to (3).

0.99s≤Sₐ₀/S_{c0}≤1.01 (1)

1.00≤Sₐ₁/Sₐ₀≤1.13 (2)

0.93≤S_{c1}/S_{c0}≤1.02 (3)

In Formulae (1) to (3), S_{c0} indicates an area of the positive electrode layer when the SOC is 0%. S_{c1} indicates an area of the positive electrode layer when the SOC is 100%. Sₐ₀ indicates an area of the negative electrode layer when the SOC is 0%. Sₐ₁ indicates an area of the negative electrode layer when the SOC is 100%.

“State Of Charge (SOC)” indicates a ratio of the charging capacity at that time to the full charging capacity of the battery. The SOC is expressed as a percentage. “SOC=0%” indicates a fully discharged state. “SOC=100%” indicates a fully charged state.

Generally, the positive electrode layer and the negative electrode layer may expand during charging. Each layer may expand not only in the thickness direction but also in the planar direction. The planar direction is an arbitrary direction perpendicular to the thickness direction. Expansion in the planar direction indicates an increase in the area. When the side end surfaces of the positive electrode layer and the negative electrode layer are flush with each other, if both the positive electrode layer and the negative electrode layer expand in the planar direction, the positive electrode layer and the negative electrode layer may come in contact with each other. It is thought that the amount of self-discharge can increase when the positive electrode layer and the negative electrode layer come in contact with each other in the planar direction.

The relationship of Formula (1) indicates that the positive electrode layer and the negative electrode layer are flush with each other in a discharged state. The relationship of Formula (2) indicates that the area of the negative electrode layer may remain unchanged or the area of the negative electrode layer may expand by 13% during charging. The relationship of Formula (3) indicates that the area of the positive electrode layer may expand or shrink by 2% during charging. When the relationships of Formulae (2) and (3) are satisfied, a reduction in the amount of self-discharge is expected. It is thought that, since at least one of the timing of the area change and the direction in the area change does not match between the positive electrode layer and the negative electrode layer during charging, opportunities for contact between the positive electrode layer and the negative electrode layer are reduced.

2. The all-solid-state battery according to the above “1” may satisfy, for example, the relationship of the following Formula (3)′.

0.93≤S_{c1}/S_{c0}<1.00 (3)′

The relationship of Formula (3)′ indicates that the area of the positive electrode layer shrinks during charging. As shown in Formula (2), the area of the negative electrode layer may remain unchanged or expand during charging. That is, the change in area of the positive electrode layer and the change in area of the negative electrode layer may be in opposite directions during charging. Therefore, the opportunities for contact between the positive electrode layer and the negative electrode layer are expected to be further reduced.

3. In the all-solid-state battery according to the above “1” or “2,” the negative electrode layer may contain, for example, at least one selected from the group consisting of a lithium titanium composite oxide (LTO), a titanium niobium composite oxide (TNO), graphite and hard carbon.

The negative electrode layer contains a negative electrode active material such as LTO. The negative electrode active material according to the above “3” does not expand during charging or has a low expansion rate during charging. It is expected that the relationship of Formula (2) will be easily satisfied when the negative electrode active material according to the above “3” is used.

4. In the all-solid-state battery according to any one of the above “1” to “3,” the positive electrode layer may contain, for example, at least one selected from the group consisting of a lithium-nickel-cobalt-manganese composite oxide (NCM), a lithium-nickel-cobalt-aluminum composite oxide (NCA), and a lithium iron phosphate (LFP).

The positive electrode layer contains a positive electrode active material such as NCM. The positive electrode active material according to the above “4” may shrink during charging. It is expected that the relationships of Formulae (3) and (3)′ will be easily satisfied when the positive electrode active material according to the above “4” is used.

5. An all-solid-state battery according to one aspect of the present disclosure includes a positive electrode layer, a separator layer and a negative electrode layer. The positive electrode layer contains at least one selected from the group consisting of NCM, NCA, and LFP. The separator layer is disposed between the positive electrode layer and the negative electrode layer. The negative electrode layer contains at least one selected from the group consisting of LTO, TNO, graphite and hard carbon. The all-solid-state battery satisfies the relationships of Formulae (1), (2) and (3)′.

Hereinafter, an embodiment of the present disclosure (which may hereinafter be abbreviated as “the present embodiment”) and an example of the present disclosure (which may hereinafter be abbreviated as “the present example”) will be described. However, the present embodiment and the present example do not limit the technical scope of the present disclosure. The present embodiment and the present example are only examples in all respects. The present embodiment and the present example are not limiting. The technical scope of the present disclosure includes all changes within the meanings and scopes equivalent to those of description of the claims. For example, it is intended from the beginning for arbitrary configurations to be extracted from the present embodiment and the present example and arbitrarily combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of an all-solid-state battery in the present embodiment; and

FIG. 2 is a table showing configurations and amounts of self-discharge of test batteries.

### DETAILED DESCRIPTION OF EMBODIMENTS

Statements of “comprise,” “include,” and “have,” and variations thereof (for example, “configured of,” etc.) are open-ended formats. An open ended format may or may not further include additional elements in addition to required elements. The statement “consisting of” is a closed format. However, even a closed format does not exclude additional elements that are normally associated impurities or irrelevant to the present disclosure technology. The statement “consisting essentially of” is a semi-closed format. In the semi-closed format, addition of elements that do not substantially affect basic and novel properties of the present disclosure technology is acceptable.

Unless otherwise specified, a numerical range such as “m to n %” includes the upper limit value and the lower limit value. That is, “m to n %” indicates a numerical range of “m % or more and n % or less.” “m % or more and n % or less” includes “more than m % and less than n %.” A measured value may be an average value of a plurality of measured values. The number of measurements may be 3 or more, 5 or more, or 10 or more. Generally, the reliability of the average value is expected to improve as the number of measurements increases. Measured values may be rounded off by rounding based on the number of significant digits. The measured values may include, for example, errors due to detection limits of measurement devices and the like.

Geometric terms (for example, “parallel,” etc.) should not be understood in a strict sense. For example, “parallel” may somewhat deviate from “parallel” in a strict sense. Geometric terms may include, for example, design, operation, and production tolerances, and errors.

The stoichiometric composition formula is only a representative example of a compound. The compound may have a non-stoichiometric composition. For example “LiCoO₂” is not limited to the composition ratio of “Li/Co/O=1/1/2” and may contain Li, Co and O in an arbitrary composition ratio. In addition, doping, substitution and the like with trace elements are also acceptable.

<All-Solid-State Battery>

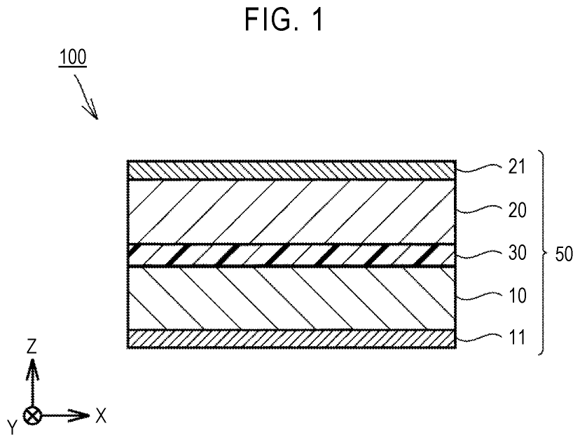

FIG. 1 is a schematic view of an all-solid-state battery according to the present embodiment. FIG. 1 schematically shows a cross section parallel to the thickness direction (Z-axis direction) of a battery 100. The battery 100 includes a power generation element 50. The battery 100 may include, for example, an outer package (not shown). The outer package may accommodate the power generation element 50. The outer package may be, for example, a pouch made of a metal foil laminate film, a metal case or the like. The battery 100 may include a single power generation element 50 alone or a plurality of power generation elements 50. The plurality of power generation elements 50 may form, for example, a series circuit or a parallel circuit.

The power generation element 50 includes a positive electrode layer 10, a separator layer 30 and a negative electrode layer 20. The separator layer 30 is disposed between the positive electrode layer 10 and the negative electrode layer 20. The separator layer 30 separates the positive electrode layer 10 from the negative electrode layer 20. The power generation element 50 may include a positive electrode current collector 11 and a negative electrode current collector 21. The positive electrode current collector 11 is in contact with the positive electrode layer 10. The negative electrode current collector 21 is in contact with the negative electrode layer 20. The positive electrode current collector 11 and the negative electrode current collector 21 may each independently have, for example, a thickness of 5 to 50 μm. The positive electrode current collector 11 and the negative electrode current collector 21 may each independently contain, for example, an Al foil, an Al alloy foil, a Cu foil, a Ni foil, or a stainless steel foil.

«Side End Surface»

The power generation element 50 has a flush structure in a discharged state. In FIG. 1, on the side end surface in the X-axis direction and the side end surface in the Y-axis direction, the positive electrode layer is flush with the negative electrode layer. That is, the relationship of the following Formula (1) is satisfied.

0.99≤Sₐ₀/S_{c0}≤1.01 (1)

Sₐ₀ indicates an area of the negative electrode layer 20 when the SOC is 0%. S_{c0} indicates an area of the positive electrode layer 10 when the SOC is 0%. “Sₐ₀/S_{c0}” may be, for example, 1.00 or more or 1.00 or less. If the “Sₐ₀/S_{c0}” is less than 0.99 or more than 1.01, it is considered that there is a step on the side end surface of the power generation element 50.

Here, the planar shapes of the positive electrode layer 10 and the negative electrode layer 20 are arbitrary. The “planar shape” is a shape on the XY plane. For example, the planar shapes of the positive electrode layer 10 and the negative electrode layer 20 may be a rectangular shape.

Due to charging, the area of the negative electrode layer 20 may remain unchanged or expand somewhat. That is, the relationship of the following Formula (2) is satisfied.

1.00≤Sₐ₁/Sₐ₀≤1.13 (2)

Sₐ₀ indicates an area of the negative electrode layer 20 when the SOC is 0%. Sₐ₁ indicates an area of the negative electrode layer 20 when the SOC is 100%. “Sₐ₁/Sₐ₀” may be, for example, 1.06 or more or 1.10 or more. “Sₐ₁/Sₐ₀” may be, for example, 1.10 or less or 1.06 or less. “Sₐ₁/Sₐ₀” may be adjusted, for example, by the type of the negative electrode active material, a mixture composition, a composite density, the thickness of the negative electrode layer 20 or the like.

During charging, the area of the positive electrode layer 10 may expand or shrink slightly. That is, the relationship of the following Formula (3) is satisfied.

0.93≤S_{c1}/S_{c0}≤1.02 (3)

S_{c0} indicates an area of the positive electrode layer 10 when the SOC is 0%. S_{c1} indicates an area of the positive electrode layer 10 when the SOC is 100%. When Formulae (2) and (3) are satisfied, a reduction in the amount of self-discharge is expected. It is thought that, since at least one of the timing of the area change and the direction in the area change does not match between the positive electrode layer 10 and the negative electrode layer 20 during charging, opportunities for contact between the positive electrode layer 10 and the negative electrode layer 20 are reduced. For example, when the relationship of “1.00<S_{c1}/S_{c0}” is satisfied, the relationship of “Sₐ₁/Sₐ₀<S_{c1}/S_{c0}” may be satisfied. “S_{c1}/S_{c0}” may be adjusted by, for example, the type of a positive electrode active material, a mixture composition, a composite density, the thickness of the positive electrode layer 10 or the like.

For example, the relationship of the following Formula (3)′ may be further satisfied.

0.93≤S_{c1}/S_{c0}<1.00 (3)′

When Formula (3)′ is satisfied, the change in area of the positive electrode layer 10 and the change in area of the negative electrode layer 20 may be in opposite directions during charging. Therefore, a reduction in the amount of self-discharge is expected. “S_{c1}/S_{c0}” may be, for example, 0.98 or less, or 0.96 or less.

For example, the relationship of the following Formula (4) may be further satisfied.

0.98≤Sₐ₁/S_{c1}≤1.10 (4)

When the relationship of Formula (4) is satisfied, a reduction in the amount of self-discharge is expected. This is thought to be because distortion during charging is reduced in the power generation element 50. “Sₐ₁/S_{c1}” may be, for example, 1.02 or more. “Sₐ₁/S_{c1}” may be, for example, 1.08 or less or 1.04 or less.

It is thought that the area of the separator layer 30 does not substantially change during charging. In the flush structure, for example, the relationships of the following Formulae (5) and (6) may be satisfied.

0.99≤Sₐ₀/Sₛ≤1.01 (5)

0.99≤S_{c0}/Sₛ≤1.01 (6)

Sₛ indicates an area of the separator layer 30.

«Positive Electrode Layer»

The positive electrode layer 10 may have, for example, a thickness of 10 to 500 μm or 50 to 200 μm. The positive electrode layer 10 may have, for example, a density (composite density) of 2 to 5 g/cm³ or 2 to 4 g/cm³. The positive electrode layer 10 contains a positive electrode active material. The positive electrode layer 10 may further contain a solid electrolyte, a conductive material, a binder and the like. The positive electrode layer 10 may contain, for example, in terms of mass fraction, 1 to 10% of a binder, 0 to 10% of a conductive material, 1 to 30% of a solid electrolyte, and the residual positive electrode active material.

(Positive Electrode Active Material)

The positive electrode active material may be, for example, in the form of particles. The positive electrode active material may have, for example, a D50 of 1 to 30 μm. “D50” indicates a particle size when a cumulative percentage from small particle sizes reaches 50% in the volume-based particle size distribution. D50 can be measured by a laser diffraction particle size distribution measurement device. The positive electrode active material causes a positive electrode reaction. The positive electrode active material may contain, for example, at least one selected from the group consisting of a lithium cobalt composite oxide (LCO), a spinel type lithium nickel manganese composite oxide (NiMn spinel), NCM, NCA, and LFP.

The NCA may have, for example, a composition represented by the general formula: Li₁₋ₐNiₓCo_{y}Al_{z}O₂ (0<x<1, 0<y<1, 0<z<1, x+y+z=1, −0.5≤a≤0.5). x may be, for example, 0.7 to 0.9. z may be, for example, 0.03 to 0.15. The NCA may contain, for example, LiNi_{0.8}Co_{0.15}Al_{0.05}O₂.

The NCM may have, for example, a composition represented by general formula: Li₁₋ₐNiₓCo_{y}Mn_{z}O₂ (0<x<1, 0<y<1, 0<z<1, x+y+z=1, −0.5≤a≤0.5). x may be, for example, 0.3 to 0.9. The NCM may contain, for example, LiNi_{1/3}Co_{1/3}Mn_{1/3}O₂, LiNi_{0.5}Co_{0.2}Mn_{0.3}O₂, LiNi_{0.6}Co_{0.3}Mn_{0.1}O₂, LiNi_{0.7}Co_{0.2}Mn_{0.1}O₂, and LiNi_{0.8}Co_{0.1}Mn_{0.1}O₂.

The LFP may have, for example, a composition such as LiFePO₄. The NiMn spinel may have, for example, a composition such as LiNi_{0.5}Mn_{1.5}O₄. The LCO may have, for example, a composition such as LiCoO₂. The positive electrode active material may be coated with, for example, an oxide solid electrolyte. The oxide solid electrolyte may contain, for example, LiNbO₃, Li₃PO₄ or the like.

“S_{c1}/S_{c0}” may decrease when the positive electrode active material shrinks during charging. For example, NCM, NCA, and LFP may shrink during charging. The volume change rate (shrinkage rate) of the positive electrode active material may be, for example, −7 to −2% or −7 to −4%. The volume change rate of the electrode active material is obtained by the following formula. The “electrode active material” indicates a positive electrode active material or a negative electrode active material.

α={(v₁/v₀)−1}×100

α [%] indicates a volume change rate.
v₀ indicates a specific volume [m³/kg] of an electrode active material when the SOC is 0%.
v₁ indicates a specific volume of an electrode active material when the SOC is 100%.

(Solid Electrolyte)

The solid electrolyte may form an ion conduction path in the electrode layer. The “electrode layer” is a general term for a positive electrode layer and a negative electrode layer. The solid electrolyte may be, for example, in the form of particles. The solid electrolyte may have, for example, a D50 of 0.1 to 3 μm. The D50 of the solid electrolyte may be, for example, 1 μm or less or 0.5 μm or less. The electrode layer may contain, for example, at least one selected from the group consisting of a sulfide solid electrolyte, an oxide solid electrolyte, a nitride solid electrolyte, a halide solid electrolyte, and a hydride solid electrolyte. The sulfide solid electrolyte may have high ion conductivity. The sulfide solid electrolyte may contain, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₄P₂S₆, Li₇P₃S₁₁, and Li₃PS₄. For example, “LiI—LiBr—Li₃PS₄” is a substance synthesized by mixing LiI, LiBr and Li₃PS₄ at an arbitrary molar ratio (substance amount ratio). The sulfide solid electrolyte may be, for example, of a glass ceramic type or an argyrodite type.

(Conductive Material)

The conductive material may form an electronic conduction path in the electrode layer. The conductive material may contain, for example, at least one selected from the group consisting of acetylene black (AB), vapor grown carbon fibers (VGCF), carbon nanotubes (CNT) and graphene flake (GF).

(Binder)

The binder may bind solid materials together. The binder may contain, for example, at least one selected from the group consisting of styrene-butadiene rubber (SBR), acrylate-butadiene rubber (ABR), polyvinylidene fluoride (PVDF), and a vinylidene fluoride-hexafluoropropylene copolymer (PVDF-HFP).

«Negative Electrode Layer»

The negative electrode layer 20 may have, for example, a thickness of 10 to 500 μm or 50 to 200 μm. The negative electrode layer 20 may have, for example, a density of 0.5 to 3 g/cm³ or 1 to 2 g/cm³. The negative electrode layer 20 contains a negative electrode active material. The negative electrode layer 20 may further contain a solid electrolyte, a conductive material, a binder and the like. The negative electrode layer 20 may contain, for example, in terms of mass fraction, 1 to 10% of a binder, 0 to 10% of a conductive material, 1 to 30% of a solid electrolyte, and the residual negative electrode active material. For example, the solid electrolyte, the conductive material, and the binder can be arbitrarily selected from the group of materials described in the above «Positive electrode layer» item. Various materials such as a solid electrolyte may be the same or different between the negative electrode layer 20 and the positive electrode layer 10.

(Negative Electrode Active Material)

The negative electrode active material may be, for example, in the form of particles. The negative electrode active material may have, for example, a D50 of 1 to 30 μm. The negative electrode active material causes a negative electrode reaction. The negative electrode active material may contain, for example, at least one selected from the group consisting of LTO, TNO, graphite and hard carbon. The LTO may have, for example, a composition such as Li₄Ti₅O₁₂. The TNO may have, for example, a composition such as TiNb₂O₇. The LTO is expected to have almost no volume change during charging. TNO, graphite, and hard carbon tend to have a low expansion rate during charging. When the expansion rate of the negative electrode active material is low during charging, “Sₐ₁/Sₐ₀” may decrease. The volume change rate (expansion rate) of the negative electrode active material may be, for example, 0 to +13%, 0 to +10%, or 0 to +6%.

«Separator Layer»

The separator layer 30 may have, for example, a thickness of 1 to 100 μm. The separator layer 30 is also called a “solid electrolyte layer.” The separator layer 30 may contain a solid electrolyte, a binder and the like. For example, the solid electrolyte and the binder can be arbitrarily selected from the group of materials described in the above «Positive electrode layer» item. The solid electrolyte and the binder may be the same or different between the separator layer and the electrode layer.

<Production of Test Battery>

### «No. 1»

### (Preparation of Negative Electrode Paste)

A negative electrode active material (Li₄Ti₅O₁₂), a conductive material (carbon material), a binder, and 1.6 parts by mass of a dispersion medium (butyl butyrate) were mixed with an ultrasonic homogenizer (model “UH-50” commercially available from SMT, hereinafter the same) for 30 minutes to form a slurry. In addition, the slurry and a solid electrolyte were mixed with an ultrasonic homogenizer for 30 minutes to form a negative electrode paste.

(Preparation of Positive Electrode Paste)

The surface of a positive electrode active material (LiNi_{1/3}Co_{1/3}Mn_{1/3}O₂) was coated with an oxide solid electrolyte (LiNbO₃). After the coating treatment, 2 parts by mass of the positive electrode active material, 0.048 parts by mass of a conductive material (VGCF), 0.407 parts by mass of a solid electrolyte, 0.016 parts by mass of a binder, and 1.3 parts by mass of a dispersion medium (butyl butyrate) were mixed with an ultrasonic homogenizer to form a positive electrode paste.

(Preparation of Separator Paste)

A binder solution was prepared. The binder solution contained 5% (in terms of mass fraction) of a solute (butadiene rubber) and the residual solvent (heptane). In a polypropylene (PP) container, a dispersion medium (heptane), a binder solution, and a solid electrolyte (LiI—LiBr—Li₃PS₄-based glass ceramics, D50=2.5 μm) were mixed with an ultrasonic homogenizer for 30 seconds. The PP container was then set in a shaker. A separator paste was formed by shaking the PP container for 3 minutes in the shaker.

(Formation of Electrode Layer)

The positive electrode paste was applied onto the surface of a positive electrode current collector (Al foil) using a blade applicator, and thereby a coating was formed. The coating was dried on a hot plate at 100° C. for 30 minutes, and thereby a positive electrode layer was formed.

The negative electrode paste was applied onto the surface of a negative electrode current collector (Al foil) using a blade applicator, and thereby a coating was formed. The coating was dried on a hot plate at 100° C. for 30 minutes, and thereby a negative electrode layer was formed. The weight per unit area [g/cm²] of the negative electrode layer was adjusted so that the opposing capacity ratio was 1.15. The “opposing capacity ratio” is a ratio of the charging capacity of the negative electrode layer per unit area to the charging capacity [mAh/cm²] of the positive electrode layer per unit area. The charging capacity of the positive electrode layer was calculated assuming that the charge specific capacity of LiNi_{1/3}Co_{1/3}Mn_{1/3}O₂ was 185 mAh/g.

(Formation of Separator Layer)

The positive electrode layer was subjected to press processing. After the press processing, the separator paste was applied onto the surface of the positive electrode layer with a die coater, and thereby a coating was formed. The coating was dried on a hot plate at 100° C. for 30 minutes, and thereby a first separator layer was formed. Roll press processing (2 t/cm², room temperature) was performed on the first separator layer and the positive electrode layer, and thereby a first unit was formed.

The negative electrode layer was subjected to press processing. After the press processing, the separator paste was applied onto the surface of the negative electrode layer with a die coater, and thereby a coating was formed. The coating was dried on a hot plate at 100° C. for 30 minutes, and thereby a second separator layer was formed. Roll press processing (2 t/cm², room temperature) was performed on the second separator layer and the negative electrode layer, and thereby a second unit was formed.

The separator paste was applied onto the surface of the substrate, and thereby a third separator layer was formed. The third separator layer was pressed onto the surface of the first separator layer by transfer processing. A laminate was formed by laminating the first unit and the second unit such that the third separator layer was attached to the second separator layer. Press processing (2 t/cm², 130° C.) is performed on the laminate, and thereby a power generation element was formed. The power generation element had the positive electrode layer, the separator layer and the negative electrode layer. The separator layer was formed by integrating the first to third separator layers.

The power generation element was processed into a disk shape by punch processing. After the processing, the power generation element had a diameter of 11.28 mm. The side end surface (outer peripheral surface) of the power generation element was flush. A pouch made of an Al laminate film was prepared as an outer package. A test battery was produced by vacuum-sealing the power generation element in the outer package. A restraining member was attached to the test battery so that a pressure of 5 MPa was applied to the power generation element.

«Nos. 2 to 12»

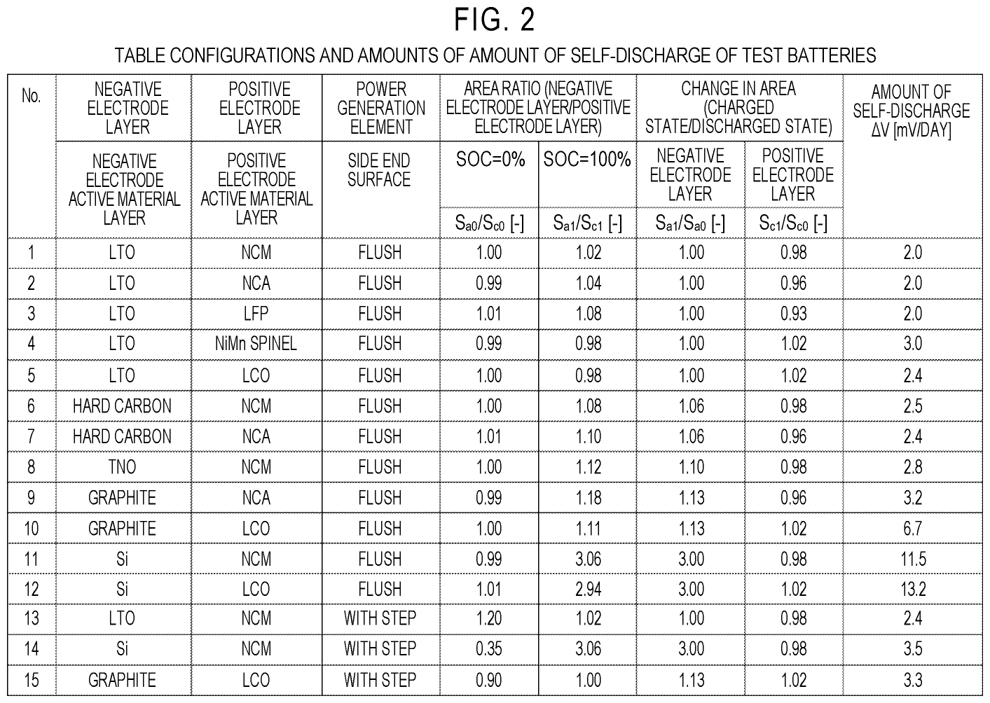

FIG. 2 is a table showing configurations and amounts of self-discharge of test batteries. A test battery was produced in the same procedure as in No. 1 except that various materials shown in the table were used as the negative electrode active material and the positive electrode active material.

«Nos. 13 to 15»

In Nos. 13 to 15, a power generation element having a step on the side end surface was produced without performing punch processing (refer to FIG. 2).

<Measurement of Amount of Self-Discharge>

The SOC of the test battery was adjusted to 100% by constant current-constant voltage type charging (current during constant current charging=1C, voltage during constant voltage charging=2.95 V, cut current=0.01C). “C” is a unit indicating a time rate of a current. 1C is a time rate at which the rated capacity of the test battery was discharged in 1 hour. In a room temperature environment, the test battery was stored for 72 hours. The amount of self-discharge was determined by the following formula.

ΔV=OCV₁−OCV₂

ΔV: amount of self-discharge [mV/day]
OCV₁: Open Circuit Voltage (OCV) after 48 hours
OCV₂: OCV after 72 hours

<Results>

In Nos. 13 to 15, the power generation element had a step on the side end surface. In Nos. 13 to 15, the amount of self-discharge was small (refer to FIG. 2). However, it is thought that there is room for improvement in material efficiency and the like.

No. 11 differed from No. 14 in that the power generation element had a flush structure. No. 11 had a larger amount of self-discharge than No. 14 (refer to FIG. 2). This is thought to be because the positive electrode layer and the negative electrode layer may come in contact with each other during charging.

In Nos. 1 to 10, the power generation element had a flush structure. Nevertheless, in Nos. 1 to 10, the amount of self-discharge tended to be small (refer to FIG. 2). In Nos. 1 to 10, the relationships of Formulae (1) to (3) were satisfied. It is thought that, since at least one of the timing of the area change and the direction in the area change did not match between the positive electrode layer and the negative electrode layer during charging, the opportunities for contact between the positive electrode layer and the negative electrode layer were reduced.

Comparing No. 9 with No. 10, it is thought that, when the relationship of Formula (3)′ was satisfied, the amount of self-discharge could be reduced. This is thought to be because the change in the area of the positive electrode layer and the change in the area of the negative electrode layer may be in opposite directions during charging.

What is claimed is:

1. An all-solid-state battery having a positive electrode layer, a separator layer and a negative electrode layer,
wherein the separator layer is disposed between the positive electrode layer and the negative electrode layer, and
wherein the all-solid-state battery satisfies relationships of Formulae (1) to (3):
0.99≤Sₐ₀/S_{c0}≤1.01 (1)
1.00≤Sₐ₁/Sₐ₀≤1.13 (2)
0.93≤S_{c1}/S_{c0}≤1.02 (3)
in Formulae (1) to (3),
S_{c0} indicates an area of the positive electrode layer when the SOC is 0%,
S_{c1} indicates an area of the positive electrode layer when the SOC is 100%,
Sₐ₀ indicates an area of the negative electrode layer when the SOC is 0%, and
Sₐ₁ indicates an area of the negative electrode layer when the SOC is 100%.

2. The all-solid-state battery according to claim 1 satisfying the relationship of Formula (3)′:
0.93≤S_{c1}/S_{c0}<1.00 (3)′.

3. The all-solid-state battery according to claim 1,
wherein the negative electrode layer contains at least one selected from the group consisting of a lithium titanium composite oxide, a titanium niobium composite oxide, graphite and hard carbon.

4. The all-solid-state battery according to claim 1,
wherein the positive electrode layer contains at least one selected from the group consisting of a lithium-nickel-cobalt-manganese composite oxide, a lithium-nickel-cobalt-aluminum composite oxide, and a lithium iron phosphate.

5. An all-solid-state battery having a positive electrode layer, a separator layer and a negative electrode layer,
wherein the positive electrode layer contains at least one selected from the group consisting of a lithium-nickel-cobalt-manganese composite oxide, a lithium-nickel-cobalt-aluminum composite oxide, and a lithium iron phosphate,
wherein the separator layer is disposed between the positive electrode layer and the negative electrode layer,
wherein the negative electrode layer contains at least one selected from the group consisting of a lithium titanium composite oxide, a titanium niobium composite oxide, graphite and hard carbon, and
wherein the all-solid-state battery satisfies relationships of Formulae (1) to (3)′:
0.99≤Sₐ₀/S_{c0}≤1.01 (1)
1.00≤Sₐ₁/Sₐ₀≤1.13 (2)
0.93≤S_{c1}/S_{c0}<1.00 (3)′
in Formulae (1) to (3)′,
S_{c0} indicates an area of the positive electrode layer when the SOC is 0%,
S_{c1} indicates an area of the positive electrode layer when the SOC is 100%,
Sₐ₀ indicates an area of the negative electrode layer when the SOC is 0%, and
Sₐ₁ indicates an area of the negative electrode layer when the SOC is 100%.
